(19) United States
(12) Patent Application Publication
(10) Pub. No.: US 2022/0274734 A1
(43) Pub. Date: Sep. 1, 2022

(54) Reinforced Composite Transport Container for Beverages

(71) Applicant: Anheuser-Busch InBev S.A., Brussels (BE)

(72) Inventors: Daniel Peirsman, Leuven (BE); Farida Bensadoun, Leuven (BE); Sarah Van Hove, Leuven (BE)

(21) Appl. No.: 16/972,247

(22) PCT Filed: Jun. 5, 2019
(86) PCT No.: PCT/EP2019/064596

§ 371 Date: Dec. 4, 2020

(30) Foreign Application Priority Data
Jun. 5, 2018 (BE) BE2018/5374

(51) Int. Cl. B65D 6/10; B65D 81/02; B65D 65/38; B65D 6/18; B65D 6/34

(52) U.S. Cl. CPC B65D 11/16; B65D 81/022; B65D 65/38; B65D 11/1833; B65D 11/22; B65D 2581/055; B65D 2581/056; B65D 2565/385

(57) ABSTRACT

A container for transporting beer bottles or beer cans has at least one part made of a structural laminate comprising a thermoplastic resin foam core and a fiber reinforced resin skin.

### FIELD OF THE INVENTION

The present is directed to the field of transport container for beverages. More in particular, the present invention is directed to a foldable or thermoformable box for transporting beverages said box comprising parts having a laminate structure.

### BACKGROUND OF THE INVENTION

In recent years, beverage export have significantly increased and, as a result said beverages are increasingly more exposed to transportation variables such as time and conditions such as light, temperature, movement and vibrations. All these conditions may impact on the stability of the beverage, in particular carbonated beverage, especially beer and the quality thereof.

Beer is a particular class of beverage where there is a direct impact of vibrations on the chemical and sensorial quality of the beer i.e. the aging of the beer. Vibrations tend to mix the oxygen in the upper part of the bottle with the beer and increase the collision of molecules thereby leading to the generation of ageing compounds. An increase of aldehydes, a decrease of bitterness compounds, haze and change of color are, among others, the effects which impact on the beer quality.

Carton boxes have been used as transport containers for beverages. Said carton boxes are returned damaged and are sensitive to humidity which directly has an impact on logistics, quality and consumer perception. Plastic boxes on the other hand fail to produce the address the transportation variables as referred to above. From the above it is clear that there is a need for an improved transport container to maintain a high quality and stable beer flavor.

The present invention meets the abovementioned drawbacks by providing a returnable improvement to boxes especially carton which provides for an environmentally friendly, returnable lights durable, recyclable, premium look and low cost container for effective and efficient containing and transporting beverages, especially beer bottles.

The above problem is addressed by a container for containing and transporting beverages especially beer i.e. beer bottles and beer cans said container comprising at least a part which is made of a reinforced sandwich laminate structure.

According to a preferred embodiment, said sandwich laminate structure comprises polymeric layers which are reinforced whereby the sandwich laminate structure has a foam core.

Light weight panels with foam core typically have certain restrictions which constitute challenges to overcome such as reduction of mechanical properties which disallows the panels being used in applications requiring load bearing capacities i.e. transport. The present invention allows for using structure with foam core by the specific configuration and material choice of the sandwich composite while at the same time improving the damping properties of the container formulated therewith. In accordance with the present invention, the resulting containers formulated with said structures can be processed in an economic and cost efficient way.

### SUMMARY OF THE INVENTION

A container for transporting beverage said container comprising at least one part made of a structural laminate comprising a thermoplastic resin foam core, a fiber reinforced resin.

### DETAILED DESCRIPTION OF THE INVENTION

The present invention is directed to a container for transporting beverage, preferably a carbonated beverage, especially beer, said container comprising at least one part made of a structural laminate comprising a thermoplastic resin foam core, a fiber reinforced resin skin, in a preferred embodiment, the core is a PU or PET foam core. In a specific embodiment the foam core is preferably a closed cell foam having a density between 20 kg/m³ to 400 kg/m³ preferably from 40 kg/m³ to 200 kg/m³ having excellent compression strength and a crystallinity below 40%. Preferred resin skins are made of PE, PET, PETE, HOPE, PETG, PEP, PLA/PLLA or mixtures thereof, preferably whereby the fibers used to reinforce the skin are made of natural fibers preferably selected from kenaf, hemp jute or flax.

According to a specific embodiment, the reinforced resin skins are made by impregnation of a fibrous web and/or textile with said resin. Typically, the weight ratio of the fiber to the resin varies from 0.1/100 to 75/25 and the thickness of the core layer varies from 0.1 mm to 20 mm and whereby the thickness of the skin layer varies from 0.01 to 10 mm, preferably from 0.01 mm to 5 mm.

According to yet another specific embodiment all parts are made of a structural laminate comprising a thermoplastic resin foam core, a fiber reinforced resin skin.

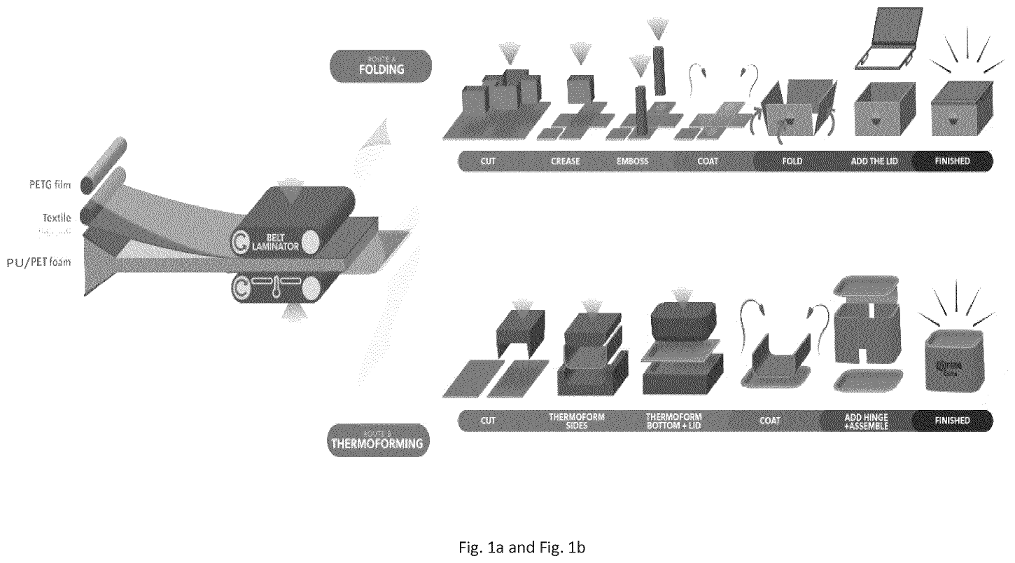

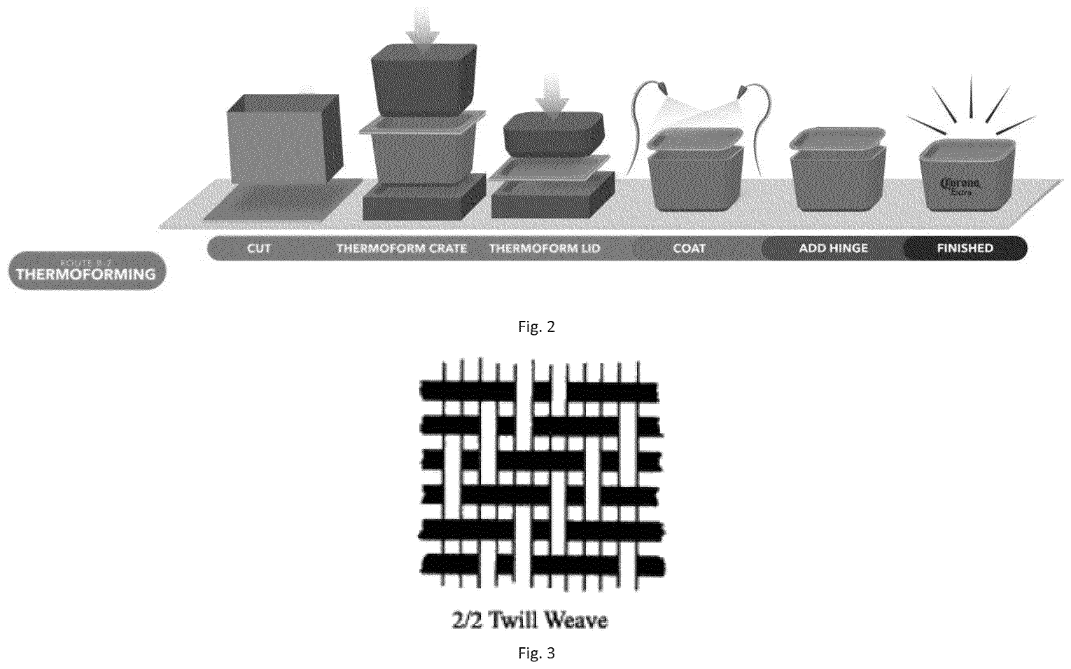

Preferred executions are boxes, especially foldable boxes container. In another embodiment, the containers have at least one layer with indented structure which holds the beverages containers such as bottles, cans and the like, f.i. beer bottles and/or beer cans within the container into a fixed position during transport. According to another process embodiment (FIG. 1a); the present invention is directed to a process for manufacturing a foldable container for transporting beverages comprising 1) producing a sheet of layer of reinforced thermoplastic material and 2) producing a foam core layer said process further comprising the steps of 3) laminating the sheet and core layer into a sheet shaped work piece 4) applying the laminate in a mould for thermoforming forcing the laminate towards the shape-giving walls of the mould cavity to thereby produce parts of the container. In accordance with another process embodiment (FIG. 1b, FIG. 2), the present invention is directed to a process for manufacturing a container for transporting beverages comprising 1) producing a sheet of layer of reinforced thermoplastic material and 2) producing a foam core layer said process further comprising the steps of 3) laminating the sheet and core layer into a sheet-shaped work piece 4) folding the laminate to thereby produce parts of the container or the container itself, 5) optionally assembling the container. Subsequently bottles or cans of beer can be placed in the container.

The transport container of the present invention comprises at least one part of the container comprising a laminate (FIG. 1), which is characterized by a layer of reinforced composite material (referred to as skin), which are applied on the face of a central core. If needed, the skin may be fixed to the central core by means of an adhesive material designed to transmit the loads applied to the skins onto the central core. The skins are in turn obtained by rolling, i.e., by superimposing and getting to adhere together a number of elementary layers of a composite material consisting of a supporting fibrous material embedded in a matrix made of resin.

The laminates of the present invention are advantageous in that these present excellent damping characteristics with a contained weight. In addition, the structure according to the present invention allows for an efficient production of said container such as a thermoformed box or a hybrid box by a folding production process (FIG. 1a) and b) and FIG. 2).

### Reinforced Thermoplastic Resin Layer (Skin)

The reinforced thermoplastic resin layer is composed of a thermoplastic resin sheet reinforced with a mixture of fibers. The thermoplastic resin used in the resin layer is not particularly restricted, and may be any of ordinary thermoplastic resins. Preferred resins in accordance with the present invention for making the skins of the present sandwich laminate are PE, PET, PETE, HDPE, PTG, PEF, PLA/PLLA, modified PET such as PETG Polyethylene terephthalate modified with glycol or mixtures thereof.

The fibers of the type usually employed for reinforcing resins may be used as a reinforcing material for such a thermoplastic resin. Preferred fiber materials include natural fibers such as jute, flax, hemp, coir, ampas, ramie and cotton, as well as the combinations of these with polypropylene, polyethylene and glass fibers. The preferred form of the natural fiber material is jute needled felt and flax. This material is cheap and available as a standard material, while owing to the nature of the felting process (web formation followed by needling), there is a certain bond between the fibers without the presence of interfering binders. Beside natural fibers, glass fibers and/or synthetic fibers like PET can be used and are present in a variety of forms including woven structures. The use of PET fibers would be advantageous to facilitate recycle in the same or even other applications. Depending on the further characteristics of the transport application of the fiber-reinforced material, fibers or combinations thereof suitable for such purpose can be selected. Fiber materials, which all have a certain moisture content: Jute, flax, hemp, coir, ampas, ramie and cotton, as well as the combinations of these with polypropylene, polyethylene and glass fibers be used and provide anisotropic mechanical property to the laminate.

Preferred suitable fibers especially for randomly oriented fiber mat have a length of generally 0.01 to 300 mm, preferably 10 to 100 mm, and a diameter of generally 2 to 20 μm, preferably 7 to 15 μm. The reinforced thermoplastic resin sheet in accordance with the present invention may be formed from the fibers described above by a known method for producing fiber-reinforced plastics (FRP). A preferred method which can be used in the present invention is to impregnate a fibrous web or a textile of a mixture of the fibers with the aforesaid thermoplastic resin. The fibrous web/textile used in this method can be formed by using sheet-forming methods known in the art such as compression molding. Alternatively, the sheet can be produced by spreading the fibers and dispersing them in water at which time a surface-active agent may be added to the dispersion for promoting the dispersing of the fibers and passing the dispersed fibers through a screen of a suitable mesh size. The weight percentage of the fibers within the resin may be varied over a range from 0.1 to 75%. Accordingly, the weight ratio of the fibers within the resin is generally from 10% wt to 65% wt, preferably from 25% wt to 60% wt, more preferably from 35% wt to 55% wt.

Desirably, the mixed fibrous web prepared as above is processed in order that in case of heat molding the laminate, the foam core layer does not decrease in dimension under the effect of heat.

The reinforced thermoplastic resin sheet is preferably formed by impregnating the mixed fibrous web/textile formed in this manner with the aforesaid thermoplastic resin. The impregnation of the thermoplastic resin in the mixed fibrous web can advantageously be achieved by impregnating the thermoplastic resin in the form of an emulsion into the fibrous web, squeezing the excess of the emulsion by a rubber roll or the like, and drying the web at about 100 to about 130° C.

According to another preferred method, the reinforced thermoplastic resin sheet can be produced by thermoforming, first impregnating a sheet or mat of the fibers with an emulsion of the thermoplastic resin having the fibers dispersed therein, or impregnating a nonwoven web of these last fibers with an emulsion of the thermoplastic resin having the fibers such as milled fibers dispersed therein, removing the excess of the emulsion, and drying the web at a temperature of about 60 to about 130° C. Typical processing conditions for thin sheets under are 130° C., 1 bar over pressure, 10 min consolidation and 10 min cooling. Tor thicker sheets, higher pressure and temperatures are used.

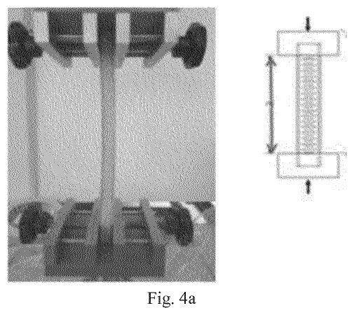

Alternatively, the reinforced thermoplastic resin sheet is formed by stacking one or more layers or fibres and a one or more layers of thermoplastic resin and subsequently heating the stack of layers to melting temperature of the thermoplastic resin. A preferred example of such stack of layers comprises, in order, i) a first layer, which is a layer of thermoplastic material such as the above mentioned PE, PET, PETE, HDPE, PTG, PEF, PLA/PLLA, or modified PET such as PETG; ii) a second layer, which is a layer of fiber material such as a mat of preferably randomly oriented fibers or a mat of woven, example given a twill 2/2 plain weave as exemplified in FIG. 3 and iii) a third layer which is a layer of thermoplastic material such as the above mentioned PE, PET, PETE, HDPE, PTC, PEE, PLA/PLLA, or modified PET such as PETG. In this stack of layers, the first and third layer are preferably identical. As previously mentioned it is clear that other stacks of layers can be made, such as a stack of i) a single layer of thermoplastic material such as the above mentioned PE, PET, PETE, HDPE, PTG, PEF, PLA/PLLA, or modified PET such as PETG and ii) a second layer, which is a layer of fiber material such as a mat of preferably randomly oriented fibers or a mat of woven, example given a twill 2/2 plain weave. Once stacked, the layers are heated to the melting temperature of the thermoplastic material of the first and third layer to allow impregnation of the fibers with the thermoplastic material and the layers are pressure rolled and cooled to create the reinforced thermoplastic resin sheet.

The thickness of the reinforced thermoplastic resin sheet (before lamination) can be varied depending upon the end use of the resulting laminate, etc. Generally, it can be 0.010 to 2 mm, preferably 0.05 to 0.5 mm.

### Core Foam Sheet

The foam can be any known foam having a density between about 20 and 400 kg/m³. Preferred foam density is density greater than 60 kg/m³, etc. Some embodiments have a density less than 120 kg/m³.

In a preferred embodiment, the foam has a thickness between the first and second major surfaces of between about 0.1 mm and 20 mm, preferably from 0.3 mm and 10 mm.

In preferred embodiments, the foam is extruded, cross linked or casted foam. Highly preferred foams In accordance with the present invention are PET foams and/or PU foams. For the production of the resin foams of the present invention, extruders are typically used. Thermoplastic resins are melted under an elevated pressure in the extruders and the molten resins are extruded through die into a low-pressure zone to produce foams.

In the production of the resin foams of the present invention, additives may be added to thermoplastic resins. By adding the additives, the viscoelastic properties of the thermoplastic resins during extrusion can be improved, whereby gasified blowing agents, solid or liquid, can be retained in the interiors of closed cells and uniformly dispersed fine cells can be formed using extruders.

Any of blowing agents including chemical blowing agents can be used in the production of the thermoplastic, resin foams of the present invention. Preferred blowing agents such as inert gases, saturated aliphatic hydrocarbons, saturated alicyclic hydrocarbons, aromatic hydrocarbons, halogenated hydrocarbons, ethers and ketones are preferred. Examples of these easy vaporizable blowing agents include carbon dioxide, supercritical carbon dioxide, nitrogen, methane, ethane, propane, butane, pentane, hexane, methylpentane, dimethylbutane, methylcyclopropane, cyclopentane, cyclohexane, methylcyclopentane, ethylcyclobutane, 1,1,2-trimethylcyclopropane, trichioromonafluoromethane, dichlorodifluoromethane, monochlorodifluoromethane, trichlorotrifluoroethane, dichlorotetrafiuoroethane, dichlorotrifluoroethane, monochlorodifluoroethane, tetrafluoroethane, dimethyl ether, 2-ethoxy ethane, acetone, methyl ethyl ketone, acetylacetone, dichlorotetrafluoroethane, monochlorotetrafluoroethane, dichloromonofluoroethane, and difluoroethane.

In the production of the thermoplastic resin foams of the present invention, stabilizer, expansion nucleating agent, pigment, filler, flame retarder and antistatic agent may be optionally added to the resin blend to improve the physical properties of the thermoplastic resin foams and molded articles thereof.

In the production of the thermoplastic resin foams of the present invention, foaming can be carried out by any of blow molding process and extrusion process using single or multiple screw extruder and tandem extruder. Dies used in the extrusion process or the blow molding process are flat die, circular die and nozzle die according to the shape of the desired foam.

Pre-expanded (primarily expanded) foam extruded through an extruder has only a low expansion ratio and usually a high density. The expansion ratio varies depending on the shapes of foams, but is about 5 times at most when the extruder foam is a sheet. In the present invention, the thus-obtained pre expanded foam, while its temperature is high immediately after extrusion, is cooled to a temperature generally in the range of 30 to 90° C. Typically the foam is generally cooled to a temperature of not higher than its glass transition temperature. When the pre-expanded foam is cooled, it is settled without having time to crystallize, and hence the crystallinity thereof is low. The crystallinity varies depending on the degree of cooling.

The resin foam can be post expanded to form a foam having a lower density. Generally, post expansion can be easily conducted by heating with water or steam. The expansion can be uniformly carried out and the resulting post-expanded foam has fine, uniform closed cells. In this way, a low-density foam of good quality can be obtained. Thus, when the pre expanded foam is heated, not only a low-density foam can be readily obtained, but the post-expanded foam can be rendered to have a higher crystallinity. A foam having a higher crystallinity, up to 40%, is a foam which is excellent with respect to the specifications in line with the present invention.

Further, the melt viscosity, die swell ratio, etc. of the thermoplastic polyester resins are adjusted in the process of the present invention to produce extrusion foam sheets. The extrusion foam sheets of the thermoplastic polyester resins have a density of preferably not higher than 10 kg/m³, more preferably not higher than 7 kg/m³. When the density exceeds 12 kg/m³, the specifications of lightweight properties and damping properties as foam sheet are less.

Preferred extrusion foam sheets have a crystallinity not higher than 40% and a molecular orientation ratio of not higher than x5 in the direction of face of foam sheet are preferred from the viewpoint of thermoformability. The foam core can be constructed homogeneous or non-homogeneous such as corrugated or honeycomb structure. Triangle or wave structure can be configured allowing density variations across the core. Using polyurethane and PET foam have been found to provide a beneficial cost/weight/strength ratio. Preferably, the foam core should have a compressive strength of minimum 0.3 MPa. The core should preferably comprise a closed cell foam, partially closed or open cell foam. The closed cell foam provides enough surface “roughness” for excellent bonding without allowing resin to fully impregnate the core The core may also include a honeycomb structure filled with foam. The use of a honeycomb may increase strength in both compression and shear.

### Formation of the Laminate

The laminate of this invention can be formed by laminating the fiber reinforced thermoplastic resin sheets to the surface of the foamed resin sheet into a unitary structure. The sheet lamination may be carried out in accordance with known methods for producing resin laminates, for example by superimposing the reinforced thermoplastic, resin sheets on both surfaces of the formed foam core and consolidating them under heat and pressure. The heating and pressurizing conditions may vary depending upon the resins constituting the respective sheets. Generally, the heating temperature is in the range of 90 to 200° C., and the pressure is between 1 and 25 bar, preferably between 1 and 5 bar.

According to another preferred method, the laminate is formed by stacking thermoplastic material layers, fiber layers and one or more foam layers in a specific, order and subsequently applying heat and pressure to the layers to melt the thermoplastic layers, thereby impregnating the fibers and unifying the thermoplastic to the foam layer. Upon cooling between rollers, a laminate of desired thickness is obtained.

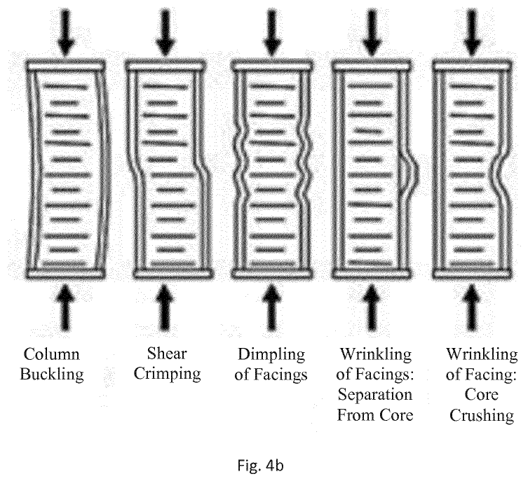

The stacking of layers is preferably symmetric and/or balanced such as to obtain a laminate sheet higher edgewise compressive strength than asymmetric and/or unbalanced laminate sheets made of the same materials, whereby a laminate is considered balanced when it has pairs of plies (layers) with same thickness and material and wherein the angles of the plies are +teta and −teta (https://nptel.ac.in/courses/101104010/lecture17/17_6.htm https://www.usna.edu/(Users/mecheng/pjoyce/composites/Short_Course_2003/7_PAX_Short_Course_Laminate-Orientation-Code.pdg). Edgewise compressive strength is measured by applying a compressive force on two opposed side edges of the laminate as shown in FIG. 4a. The force is thus applied in a direction parallel to the plain of the laminate sheet and the force applied on the laminate at first failure (the different types of failure are illustrated in FIG. 4b is a measure for the edge compressive strength of the laminate.

A preferred laminate for the present invention can be obtained by stacking, in subsequent order: a PETG film, a fibrous web/textile of jute, a PETG film, a PET foam, a PETG film, a fibrous web/textile of jute and a PETG film.

The proportions of the foam core sheet layer and the reinforced resin layer in the laminate of this invention can be varied depending upon the specific properties required of the laminate, for example. Preferably therefore, the weight ratio of the reinforced resin layer to the foam core is generally from 1:1 to 40:1, preferably from 4:1 to 10:1.

In accordance with a preferred structure of the present invention, PET and PU is selected as core material either being present as foam or as foil with as skin PET reinforced with natural fibers. Preferred natural fibers include kenaf, hemp, flax, jute.

In accordance with a separate embodiment of the present invention, the present invention is directed to foldable laminate structures comprising a thermoplastic resin foam core, a resin skin whereby the laminate structure in accordance with the present invention is specifically designed and formulated such as to ensure that the laminate of the present invention is suitable to also withstand the directional forces of the folding. With respect to configuration, the laminate structure and composition may locally vary in those zones where folding will occur, in those zones, the fibers can be selected and be different than those fibers being present in the other zones of the laminate. In addition the orientation of said fibers being present in the foldable region can be such as to ensure the minimum degree of elasticity provided in the foldable direction. Parameters such as length and thickness and moisture content of the fibers may be optimized such as to meet the minimum degree of elasticity.

The following examples further illustrate the present invention.

Material and Lay-Up Details

The damping properties of the above laminate structure have been determined by dynamic tests known in the art, more in particular a sample of the laminate is set-up in a three point bending mode and an oscillation of 1 Hz is applied under a range of temperatures to determine the E′ storage modules (a measurement of the material's stored energy (elastic response of the material)—the value being different from the Young's modulus value and also called the in-phase component); the E″ Loss modulus (a measurement of the material's viscous response and also a measure of the energy dissipated as heat—this value also called the out of phase component); and the Tan delta damping factor (calculation of the tangent of the phase angel and the ratio of E″/E′—the higher the Tan delta the higher the damping coefficient and the more efficient the material absorbs energy). Test results confirmed that the laminate structures disclosed above have a substantially higher Tan delta compared to standard beer crates manufacturing material such as HDPE and PP.

The damping properties of the above laminate structure have been determined by dynamic tests known in the art, more in particular a sample of the laminate is set-up in a three point bending mode and an oscillation of 1 Hz is applied under a range of temperatures to determine the E storage modules (a measurement of the materials stored energy (elastic response of the material)—the value being different from the Young's modulus value and also called the in phase component); the E″ Loss modulus (a measurement of the material's viscous response and also a measure of the energy dissipated as heat—this value also called the out of phase component); and the Tan delta damping factor (calculation of the tangent of the phase angel and the ratio of E″E′—the higher the Tan delta the higher the damping coefficient and the more efficient the material absorbs energy). Test results confirmed that the laminate structures disclosed above have a substantially higher Tan delta compared to standard beer crates manufacturing material such as HDPE and PP.

### Processing of the Laminate

Meyer Flatbed lamination system® with temperature (heating/cooling) and pressure control similar model to KFK X was used. The determination on the laminate thickness is done using thickness rollers located in the feeding and heating zone where it presses the material to the right thickness using pressure. While exiting the heating zone, the material passes through an optional thickness adjustment area (cooling zone for thickness adjustment and to ensure homogeneousness of the panels) where its structure and thickness are fixed before the material exits the belt. The belt used can process material with thicknesses from 5 mm to 150 mm.

### Processing Conditions

Heating zone length 3650 mm
Cooling zone length: 1150 mm
Lamination speed: 2 m/min
Pressure applied: 2 bars
Press plate only on top, bottom part only with pressure rollers

TABLE 1

| | FIBER | | | |
|---|---|---|---|---|
| FIBER | STRUCTURE/LAYUP | POLYMER | FOAM | FOAM CONFIGURATION |
| Glass fiber | Plain weave | PP | PET | Closed cell foam |
| Natural fiber + | Random mat | PETG | PET | Closed cell foam |
| Glass fiber | | | | |
| Natural fiber + | Twill 2 × 2 | PET | rPET | Closed cell foam |
| Aramide fiber | | | | |
| Flax | Satin weave | PEF | PET | Closed cell foam |
| Aramide | Double Twill 2 × 2 | PP | Bio-PU | Closed cell foam |
| Flax | Braid | PP | PU | Closed cell foam |
| Coir fiber | Chopped strand | PLA | PU | Perforated closed cell |
| | Random mat | | | foam |
| Bamboo fiber | Long strand random | PET | PU | Partially Closed cell |
| | mat | | | foam |
| Glass fiber | Quasi-UD | POM | PET | Partially dosed cell foam |
| Hemp | Unidirectional | PLA | PET | Closed cell foam |
| Ramie fiber + PP | Quasi-isotropic | PETG | PET | Open cell foam |
| fiber | | | | |
| Carbon fiber | 3D woven | TPU | PU | Partially dosed cell |
| | | | | foam |
| PP fibers* | Twill 2.2 | PP | | Partially closed cell |
| | | | | foam |
| PET fibers* | Plain weave | PET | PET | Closed cell foam |
| PET fibers | Triaxial direction | PE | PET | Closed cell foam |
| PP fibers** | Biaxial | PP | PU | Partially dosed cell |

foam

*self-reinforced polymers
**sopp

### Results

In accordance with the present invention and Table 1 specifications, laminated/folded and laminated/thermoformed containers were made. All these containers qualified as light, strong, vibration damping, premium, low cost and environmentally-friendly container. Vibration testing was done in accordance with ISO 6721-1:2011.

### Processing of the Laminate to Crates

Converting or processing the laminate to a crate can be done though a multitude of processes well known in the art of forming carton crates such as folding, by thermoforming or by combination of both techniques.

In accordance with a first process as exemplified in FIG. 1a & b, the laminate is formed as a sheet and subsequently cut in an appropriate flat shape. Subsequently this flat shape is processed by one or more steps of folding, creasing and/or thermoforming to a three-dimensional structure defining the crate, which is locked in place by welding, stitching, gluing or otherwise adhering of parts of the crate to obtain a rigid crate.

According to a second process, the different layers of the laminate are cut or made in an appropriate shape and subsequently laminated to obtain a flat shape that can be further processed by one or more steps of folding, creasing and/or thermoforming to a three dimensional structure defining the crate, which is locked in place by welding, stitching, gluing or otherwise adhering of parts of the crate to obtain a rigid crate.

Independent of the process applied for processing the laminate into a crate, it is preferred to apply a finish to those edges of the laminate where, after creation of the crate, the foam layer is uncovered. Such finish of the edges can be done by making one of the inner or outer skin layers protruding from the concerned edge and wrapping this protruding part over the foam edge to overlap with the opposed outer or inner skin layer, where it can be fixed by welding, gluing, stitching or other fixation techniques well known in the art. Alternatively the edges can be finished by application of a cover that is clinched, press-fitted, glued or otherwise fixed to the crate along the edges where foam is exposed to the ambient. Another option of finishing the edges is by application of a sealing material such as silicone, a PET melt or other compatible melt over the exposed foam.

According to a preferred process, specific functionalities can be added or implement to the crate, independent of the process chosen for manufacturing the crate (cutting post lamination or cutting/manufacturing the different layers in a desired shape prior to lamination). Such specific functionalities include but are not limited to: embossing of the bottom of the crate to define specific bottle or can slots, allowing holding or locking the bottles/cans in place; creation of reinforcement ribs in the crate to locally reinforce the crate, example given by locally heating the crate above the activation temperature of the chemical blowing agent of the foam, thereby allowing expansion of the foam post crate forming; creation of a protruding pattern at a bottom surface of the crate to allow stable stacking of crates; creation of handles in the crate, either in the sidewalks of the crate or inside the crate, by cutting away material for the sidewalls and finishing the edges were foam is exposed due to cutting and/or by inserting a handle in the crate and fixing it to the crate by welding, gluing, stitching or other fixation techniques; providing a cover to the crate configured to contact the top surface of any bottles or cans stored in the crate and to contact the bottom surface of a crate stacked on top of the closed crate; providing draining holes in the bottom of the crate and so forth.

The crate obtained by one of the above processes can be either a load bearing crate, ie. a crate capable of carrying one or more filled crates stacked on top of it or non-load bearing crates, wherein in case of stacking one or more filled crates on top of one another, the load bearing functionality is provided by the bottles or cans stored in the crate.

1. A container for transporting beer bottles or beer cans has at least one part made of a structural laminate comprising a thermoplastic resin foam core and a fiber reinforced resin skin.

2. The container according to claim 1 whereby said core is a PU or PET foam core.

3. The container as claimed in claim 1 in which the resin foam core is a closed cell foam having a density between 20 kg/m³ to 400 kg/m³, preferably from 40 kg/m³ to 200 kg/m³, a compression strength of minimum 0.3 MPa, and/or a maximum crystallinity of 40%.

4. The container as claimed in claim 1 whereby the resin skin is made of thermoplastics and preferably PE, PET, HDPE, PETG, PEF, PLA/PLLA, or mixtures thereof.

5. The container as claimed claim 1 whereby the fibers used to reinforce the skin are made of natural fibers preferably selected from kenaf, hemp, jute, or flax.

6. The container as claimed in claim 1 whereby the reinforced resin skin is made by impregnation of a fibrous web or a fiber oriented textile with said resin.

7. The container as claimed in claim 1 whereby the weight ratio of the fiber to the resin varies from 0.1/100 to 75/25.

8. The container as claimed in claim 1 whereby the thickness of the core layer varies from 0.1 mm and 20 mm, preferably from 0.3 mm and 10 mm, and whereby the thickness of the skin layer varies from 0.010 mm to 2 mm, preferably 0.05 mm to 0.5 mm.

9. The container for transporting beverage according to claim 1 where all parts are made of a structural laminate comprising a thermoplastic resin foam core, and a fiber reinforced resin skin.

10. A container according to claim 1 which is a foldable container.

11. A thermoformed container according to claim 1.

12. A container according to claim 1 which is a box holding beer bottles or beer cans.

13. A container according to claim 1 where foam and/or skin is made of recyclable material.

14. A box according to claim 12 having at least one layer with indented structure which holds the beer bottles/cans in a fixed position during transport.

15. A process for manufacturing a thermoformed container for transporting beverages comprising
(1) producing a sheet of layer of reinforced thermoplastic material, and
(2) producing a foam core layer,
said process further comprising the steps of
(3) laminating the sheet and core layer into a sheet-shaped work piece
(4) applying the laminate in a mould for thermoforming forcing the laminate towards the shape-giving walls of the mould cavity thereby to produce parts of the container.

16. A process for manufacturing a foldable container for transporting beverages comprising
(1) producing a sheet of layer of reinforced thermoplastic material, and
(2) producing a foam core layer,
said process further comprising the steps of
(3) laminating the sheet and core layer into a sheet-shaped work piece
(4) folding the laminate thereby to produce parts of the container.
